(19) United States
(12) Patent Application Publication
(10) Pub. No.: US 2026/0227555 A1
(43) Pub. Date: Aug. 6, 2026

(54) OPTICAL INTERFERENCE FILTER

(71) Applicant: VIAVI Solutions Inc., Chandler, AZ (US)

(72) Inventors: Fred VAN MILLIGEN, Santa Rosa, CA (US); Georg J. OCKENFUSS, Santa Rosa, CA (US)

(21) Appl. No.: 19/042,445

(22) Filed: Jan. 31, 2025

(51) Int. Cl. G02B 5/28

(52) U.S. Cl. CPC G02B 5/28

(57) ABSTRACT

In some implementations, an optical interference filter includes a substrate and a layer stack disposed on the substrate. The layer stack includes a first set of layers and a second set of layers. Each layer of the first set of layers comprises a first compressive material. Each layer of the second set of layers comprises a second compressive material that is different than the first compressive material. The layer stack does not include layers that fully compensate for a compressive stress of the first set of layers and the second set of layers. A net stress of the layer stack is approximately zero megapascals.

### BACKGROUND

An optical device may be utilized to capture information concerning light. For example, the optical device may capture information relating to a set of wavelengths associated with the light. The optical device may include a set of sensor elements (e.g., optical sensors, spectral sensors, and/or image sensors) that capture the information. For example, an array of sensor elements may be utilized to capture information relating to multiple wavelengths. The array of sensor elements may be associated with an optical filter. The optical filter may include a passband associated with a first wavelength range of light that is passed to the array of sensor elements. The optical filter may be associated with blocking a second wavelength range of light from being passed to the array of sensor elements.

### SUMMARY

In some implementations, a method comprising: forming, using a sputtering technique, a first set of layers and a second set of layers on a first wafer, wherein each layer of the first set of layers comprises a first compressive material, and wherein each layer of the second set of layers comprises a second compressive material that is different than the first compressive material; singulating the first set of layers and the second set of layers to form a plurality of layer stacks; forming respective patio structures for the plurality of layer stacks; releasing the plurality of layer stacks from the first wafer; and transferring the plurality of layer stacks to a second wafer, wherein a maximum thickness of the second wafer is less than a maximum thickness of the first wafer, and wherein a net stress of each layer stack on the second wafer is approximately zero megapascals.

In some implementations, an optical interference filter includes a substrate; and a layer stack disposed on the substrate, wherein the layer stack includes: a first set of layers, and a second set of layers, wherein: each layer of the first set of layers comprises a first compressive material, each layer of the second set of layers comprises a second compressive material that is different than the first compressive material, the layer stack does not include layers that fully compensate for a compressive stress of the first set of layers and the second set of layers, and a net stress of the layer stack is approximately zero megapascals.

In some implementations, a wafer includes a plurality of optical interference filters, wherein each optical interference filter includes: a portion of the wafer that serves as a substrate for the optical interference filter; and a layer stack disposed on the substrate, wherein the layer stack includes: a first set of layers, and a second set of layers, wherein: each layer of the first set of layers comprises a first compressive material, each layer of the second set of layers comprises a second compressive material that is different than the first compressive material, the layer stack does not include layers that fully compensate for a compressive stress of the first set of layers and the second set of layers, and a net stress of the layer stack is approximately zero megapascals.

### BRIEF DESCRIPTION OF THE DRAWINGS

FIG. 1 is a diagram of an overview of an example implementation described herein.

FIG. 2 is a diagram of an example optical filter.

FIG. 3 is a diagram of an example wafer.

FIGS. 4A-4F are diagrams associated with an example process associated with forming optical filters.

FIGS. 5A-5E are diagrams associated with an example process associated with forming optical filters.

FIG. 6 is a flowchart of an example process associated with forming optical filters.

### DETAILED DESCRIPTION

The following detailed description of example implementations refers to the accompanying drawings. The same reference numbers in different drawings may identify the same or similar elements. The following description uses a sensor system (e.g., an optical sensor system) as an example. However, the techniques, principles, procedures, and methods described herein may be used with any sensor system, including but not limited to other sensor systems that include optical sensors and/or optical filters.

An optical filter may be manufactured by forming one or more layers on a substrate. For example, a conventional optical filter may include alternating layers of at least a first material, a second material, and so on to allow the conventional optical filter to pass a threshold percentage of light (e.g., at least 65% of light) associated with a particular spectral range (e.g., a spectral range of 800 to 1600 nanometers (nm)). However, in many cases, a stress of each of the layers is compressive (e.g., the stress of each of the layers is less than 0 megapascals (MPa)), which causes a stress (e.g., a net stress) of the one or more layers to be compressive. Consequently, this causes the substrate to warp (e.g., to bend or to bow). This causes the one or more layers to suffer from coating runoff, which leads to formation of low-quality layers that can introduce defects or allow defects to propagate through the conventional optical filter. This can degrade a performance, manufacturability, and/or a reliability of the conventional optical filter. Further, a warped substrate causes the conventional optical filter to be more fragile (e.g., as compared to a flat optical filter) and/or makes transporting, handling, and/or use of the conventional optical filter difficult. In some cases, layers that comprise a tensile material can be disposed on the substrate to compensate for a compressive stress of other layers, but this alters an optical performance of the optical filter (e.g., in terms transmission rate, spectral range, along with other examples).

Some implementations described herein provide an optical filter that includes a layer stack disposed on the substrate. The layer stack includes layers that comprise compressive materials. For example, the layer stack may include a first set of layers that comprise a first compressive material and a second set of layers that comprise a second compressive material (e.g., that is different than the first compressive material). Further, the layer stack does not include layers that fully compensate for a compressive stress of the first set of layers and the second set of layers (e.g., does not include any tensile layers to compensate for a compressive stress of the set of layers and the second set of layers in the layer stack). Notably, in some implementations, a net stress of the layer stack is approximately zero (0) MPa. In some implementations, this is because the layer stack is formed on another substrate (e.g., a thicker substrate), released from the other substrate, and transferred to the substrate. Thus, any stress induced in the layer stack during formation of the layer stack on the other substrate is decreased (e.g., as a result of the layer stack relaxing upon release from the other substrate) to zero, or near-zero, MPa, and transferring the layer stack to the substrate induces little to no additional stress in the layer stack.

Thus, the optical filter may lay flat (e.g., with little to no curling or bending). For example, because the net stress of the layer stack is approximately zero MPa, the substrate is not likely to warp (e.g., even when the substrate is thin and would otherwise warp if the layer stack were formed on the substrate). In this way, a warpage of the substrate (and therefore the optical filter) is reduced. Further, in some implementations, because the optical filter has a small horizontal footprint (e.g., on the order of a few millimeters), any residual stress that may remain in the layer stack does not result in substantial warpage of the substrate. This improves a durability of the optical filter and/or makes transporting, handling, and/or use of the optical filter easier, as compared to a conventional optical filter with a substrate that suffers from high warpage.

Further, because the layer stack is formed on a thicker substrate that is subject to less warpage, the layer stack is subject to reduced coating runoff and therefore also subject to less formation variability that would otherwise result from increased coating runoff. This reduces a likelihood of formation of low-quality layers in the layer stack, and therefore reduces a likelihood of defects being introduced in or allowed to propagate through the optical filter. Therefore, a performance, a manufacturability, and/or a reliability of the optical filter is improved as compared to that of a conventional optical filter.

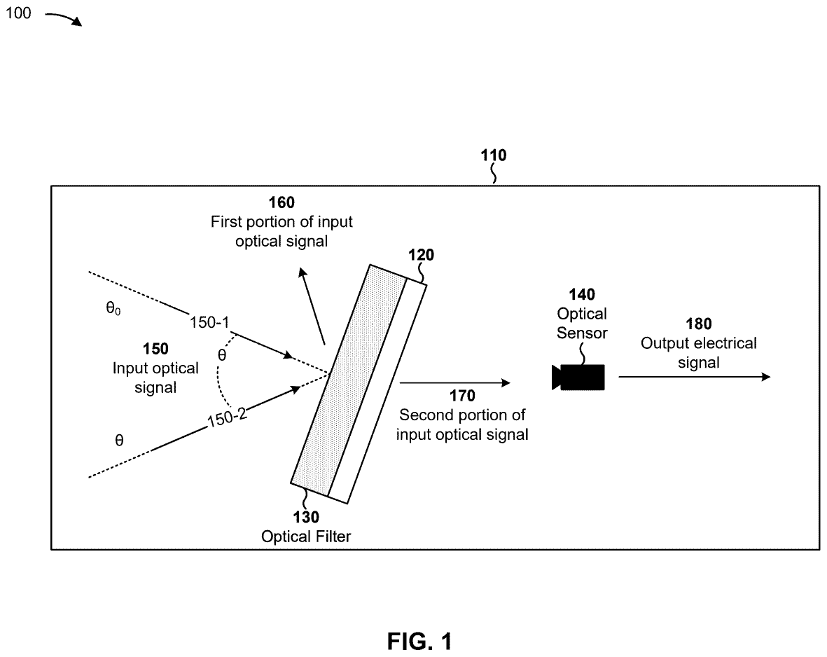

FIG. 1 is a diagram of an overview of an example implementation 100 described herein. As shown in FIG. 1, example implementation 100 includes a sensor system 110. Sensor system 110 may be a portion of an optical system and may provide an electrical output corresponding to a sensor determination. Sensor system 110 includes an optical filter structure 120, which includes an optical filter 130, and an optical sensor 140. For example, optical filter structure 120 may include an optical filter 130 that performs a passband filtering functionality. In another example, an optical filter 130 may be aligned to an array of sensor elements of optical sensor 140.

Although some implementations, described herein, may be described in terms of an optical filter in a sensor system, implementations described herein may be used in another type of system, may be used external to a sensor system, or in other configurations.

As further shown in FIG. 1, and by reference number 150, an input optical signal is directed toward optical filter structure 120 at one or more angles of incidence, θ. For example, input optical signals 150-1 and 150-2 may be directed toward optical filter 130 at angles of incidence θ₀ (e.g., a configured angle of incidence) and θ. The input optical signal may include, but is not limited to, light associated with a particular spectral range (e.g., a spectral range centered at approximately 900 nm, such as a spectral range of 800 nm to 1000 nm; a spectral range of 800 nm to 1600 nm; a spectral range of 800 nm to 1100 nm; a spectral range of 1400 nm to 1600 nm, such as with a peak wavelength of 1550 nm; a spectral range of 500 nm to 5500 nm; or another spectral range). For example, an optical transmitter may direct the light toward optical sensor 140 to permit optical sensor 140 to perform a measurement of the light. In another example, the optical transmitter may direct another spectral range of light for another functionality, such as a testing functionality, a sensing functionality, or a communications functionality, among other examples.

As further shown in FIG. 1, and by reference number 160, a first portion of the optical signal with a first spectral range is not passed through by optical filter 130 and optical filter structure 120. For example, dielectric layer stacks of dielectric thin film layers, which may include high index material layers and low index material layers of optical filter 130, may cause the first portion of light to be reflected in a first direction, to be absorbed, or the like. In this case, the first portion of light may be a threshold portion of light incident on optical filter 130 not included in a bandpass of optical filter 130, such as greater than 95% of light not within a particular spectral range centered at approximately 900 nm. As shown by reference number 170, a second portion of the optical signal is passed through by optical filter 130 and optical filter structure 120. For example, optical filter 130 may pass through the second portion of light with a second spectral range in a second direction toward optical sensor 140. In this case, the second portion of light may be a threshold portion of light incident on optical filter 130 within a bandpass of optical filter 130, such as greater than 50% of incident light in a spectral range centered at approximately 900 nm. The second portion of light may pass through the optical filter 130 with less than a threshold angle shift, as described in more detail herein.

As further shown in FIG. 1, based on the second portion of the optical signal being passed to optical sensor 140, optical sensor 140 may provide an output electrical signal 180 for sensor system 110, such as for use in imaging, ambient light sensing, detecting the presence of an object, performing a measurement, or facilitating communication, among other examples. In some implementations, another arrangement of optical filter 130 and optical sensor 140 may be utilized. For example, rather than passing the second portion of the optical signal collinearly with the input optical signal, optical filter 130 may direct the second portion of the optical signal in another direction toward a differently-located optical sensor 140.

As indicated above, FIG. 1 is provided as an example. Other examples may differ from what is described with regard to FIG. 1.

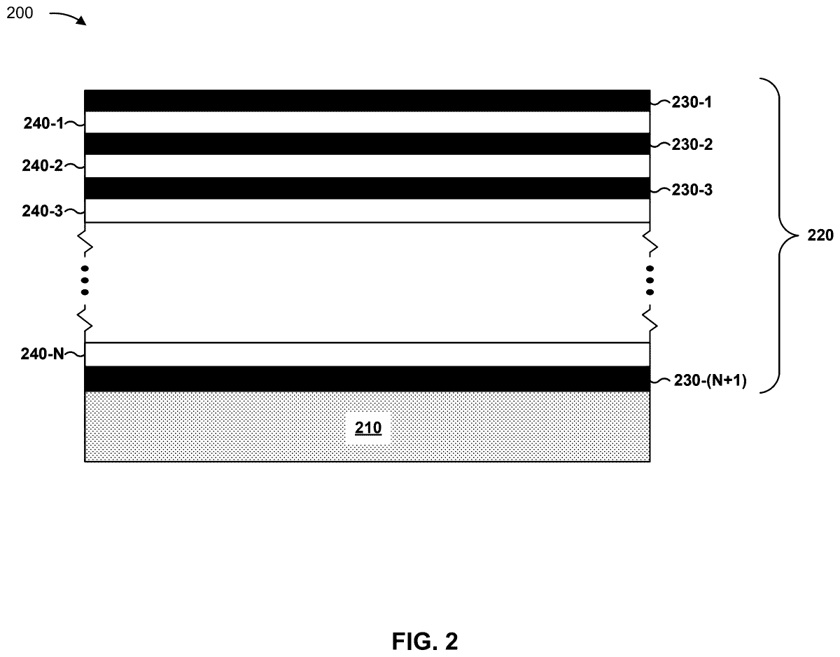

FIG. 2 is a diagram of an example optical filter 200. In some implementations, the optical filter 200 may be an optical interference filter and/or may comprise at least one of a spectral filter, a multispectral filter, a bandpass filter, a blocking filter, a long-wave pass filter, a short-wave pass filter, a dichroic filter, a linear variable filter, a circular variable filter, a Fabry-Perot filter, a plasmonic filter, a photonic crystal filter, a nanostructure or metamaterial filter, an absorbent filter, a beam splitter, a polarizing beam splitter, a notch filter, an anti-reflection filter, a reflector, or a mirror, among other examples. FIG. 2 shows an example stack up of the optical filter 200. As further shown in FIG. 2, the optical filter 200 includes a substrate 210 and a layer stack 220.

The substrate 210 may comprise a glass substrate, a polymer substrate, a polycarbonate substrate, a metal substrate, a silicon (Si) substrate, a germanium (Ge) substrate, or an active device wafer (e.g., that comprises a photodiode (PD), a PD array, an avalanche photodiode (APD), an APD array, a charge-coupled device (CCD) sensor, and/or a complementary metal oxide semiconductor (CMOS) sensor, among other examples).

The layer stack 220 may be disposed on (e.g., directly on) the substrate 210. For example, as shown in FIG. 2, the layer stack 220 may be disposed on a single surface (e.g., the top surface) of the substrate 210. The layer stack 220 may include one or more sets of layers. For example, the layer stack 220 may include a first set of layers 230 (e.g., a first set of layers 230-1 through 230-(N+1) (N≥1)) (also referred to herein as A layers) and a second set of layers 240 (e.g., a second set of layers 240-1 through 240-N) (also referred to herein as B layers). In some implementations, the first set of layers 230 and the second set of layers 240 may be arranged in a particular order (e.g., an alternating layer order), such as an (A-B)ₘ (m≥1) order, an (A-B)ₘ-A order, a (B-A)ₘ order, a B-(B-A)ₘ order, or another order. For example, as shown in FIG. 2, the first set of layers 230 and the second set of layers 240 are positioned in an (A-B)N-A order with an A layer (e.g., layer 230-1) disposed at a surface (e.g., a top surface) of the optical filter 200 and an A layer (e.g., layer 230-(N+1)) disposed on a surface (e.g., a top surface) of the substrate 210. While FIG. 2 shows an example with a first set of layers 230 and a second set of layers 240 arranged in a particular order, any number of different sets of layers may be included in the layer stack 220 (e.g., the layer stack 220 may additionally include a third set of layers and/or more sets of layers) and arranged in a particular order (e.g., a periodic order, or another type of order).

The layer stack 220 may include layers that comprise compressive materials. Accordingly, a stress of each layer of the layer stack 220 is less than or equal to 0 megapascals (MPa)). For example, a layer of the layer stack 220 may comprise at least one of a silicon (Si) material, a silicon and hydrogen (SiH) material, a hydrogenated silicon (Si:H) material, a hydrogenated silicon with helium (Si:H—He) material, an amorphous silicon (a-Si) material, a silicon nitride (SiN) material, a germanium (Ge) material, a hydrogenated germanium (Ge:H) material, a silicon germanium (SiGe) material, a hydrogenated silicon germanium (SiGe:H) material, a silicon carbide (SiC) material, a hydrogenated silicon carbide (SiC:H) material, a silicon dioxide (SiO₂) material, a tantalum pentoxide (Ta₂O₅) material, a niobium pentoxide (Nb₂O₅) material, a niobium titanium oxide (NbTiOₓ) material, a niobium tantalum pentoxide (Nb₂₋ₓTaxO₅) material, a titanium dioxide (TiO₂) material, an aluminum oxide (Al₂O₃) material, a zirconium oxide (ZrO₂) material, an yttrium oxide (Y₂O₃) material, or a hafnium oxide (HfO₂) material, among other examples. In some implementations, the layer stack 220 may include layers that comprise different compressive materials. For example, the first set of layers 230 (e.g., each layer of the first set of layers 230) may comprise a first compressive material and the second set of layers 240 (e.g., each layer of the second set of layers 240) may comprise a second compressive material (e.g., that is different than the first compressive material, such as in terms of a stoichiometric formulation, by inclusion of one or more elements not included in the first compressive material, or by exclusion of one or more elements that are included in the first compressive material).

In some implementations, the layer stack 220 does not include a layer that comprises a tensile material (e.g., does not include any tensile layers). That is, the layer stack 220 may not include any layer that comprises a tensile material to compensate (e.g., in terms of stress) for layers included in the layer stack 220 that comprise compressive materials. For example, the layer stack 220 may not include a layer that comprises an aluminum nitride (AlN) material (e.g., that is formulated to be tensile). Alternatively, in some implementations, the layer stack 220 may include one or more other layers that include a tensile material, but a stress (e.g., a net stress) of the one or more other layers does not fully compensate for a compressive stress (e.g., a net compressive stress) of layers included in the layer stack 220 that comprise compressive materials. For example, a net stress of the layer stack 220, even when including the one or more other layers, may be less than or equal to 0 MPa. Thus, the layer stack 220 may not include layers that fully compensate for a compressive stress (e.g., a net compressive stress) of sets of layers of the layer stack 220 (e.g., the layer stack 220 does not include layers that fully compensate for a compressive stress of the first set of layers 230 and the second set of layers 240).

In some implementations, one or more other layers may be included in the optical filter 200, such as one or more protective layers, one or more cap layers (e.g., to provide environmental protection to layer stack 220), and/or one or more layers to provide one or more other filtering functionalities (e.g., a blocker or an anti-reflection coating, among other examples). For example, in the single surface configuration, an additional layer (e.g., a cap layer), such as a dielectric layer (e.g., that comprises an oxide material, such as a silicon dioxide (SiO₂) material, a zirconium dioxide (ZrO₂) material, and/or an yttrium oxide (Y₂O₃) material; a nitride material, such as a silicon nitride (Si₃N₄) material, a titanium nitride (TiN) material, and/or a zirconium nitride (ZrN) material; and/or another material that provides environmental protection), may be disposed on a surface (e.g., a top surface) of the layer stack 220 or between the layer stack 220 and the substrate 210.

The optical filter 200 may have a cuboid shape, or another polygonal shape. For example, the optical filter may have six rectangular faces (e.g., where the substrate 210 serves as one face, and sides of the layer stack 220 serve as the other faces). In some implementations, a minimum horizontal dimension of the layer stack 220 (e.g., a minimum distance measured between corresponding points of opposite faces of the layer stack 220) may satisfy (e.g., may be greater than) a horizontal dimension threshold, such as 1 millimeter (mm). In this way, because of a lower bound on a size of the layer stack 220 in a horizontal plane, a usability of the optical filter 200 is enhanced, such as for use with a multi-pixel optical sensor with a large sensor surface in the horizontal plane. Additionally, or alternatively, a minimum thickness of the layer stack 220 may satisfy (e.g., may be greater than) a layer stack thickness threshold, such as 10 micrometers (μm). In this way, an optical response of the optical filter 200 is enhanced, such as by increasing an efficiency of transmission of a desired wavelength (e.g., by increasing a minimum optical path length through the layer stack 220). Additionally, or alternatively, a maximum thickness of the substrate 210 may satisfy (e.g., may be less than or equal to) a substrate thickness threshold, such as 100 μm, 150 μm, 200 μm, 250 μm, 300 μm, 350 μm, or 400 μm. This reduces an overall thickness and weight of the optical filter 200, enabling use of the optical filter 200 in compact systems and devices, such as a user device (e.g., a smart phone), where thickness and weight are critical constraints.

In some implementations, an aspect ratio of a maximum thickness of the layer stack 220 and a maximum horizontal dimension of the layer stack 220 may satisfy (e.g., be less than) an aspect ratio, such as 1:100, 1:200, 1:300, or 1:400, along with other examples. In this way, the optical filter 200 may have a “long” and “thin” profile that further enables use of the optical filter 200 in compact systems.

In some implementations, a stress (e.g., a net stress) of the layer stack 220 may be approximately zero (0) MPa (e.g., within a tolerance, wherein the tolerance is less than or equal to 5 MPa). In some implementations, this is a result of the layer stack 220 being formed on another substrate, released from the other substrate, and transferred to the substrate 210 (e.g., such that the layer stack 220 is disposed on the surface of the substrate 210), as further described herein. For example, a stress (e.g., a net stress) may be induced in the layer stack 220 during formation of the layer stack 220 on the other substrate (e.g., when using a high-temperature formation process that induces thermal stress due to differences in coefficients of thermal expansion (CTEs) of the materials in the layer stack 220 and the other substrate). The layer stack 220 may then relax when released from the other substrate, which causes the stress (e.g., the net stress) of the layer stack 220 to decrease to zero, or near-zero, MPa. The layer stack 220 may then be transferred to the substrate 210 such that little to no additional stress is induced in the layer stack 220 by the substrate 210.

A Stoney equation describes a curvature (e.g., an amount of bending) of a substrate due to stresses of films formed on the substrate, represented by the following:

$$R = \frac{6 ( 1 - {v}_{s} ) {σ}_{f}}{{E}_{s} {h}_{s}^{2}} ,$$

where R is the curvature of the substrate (e.g., a radius of the curvature, in meters (m)), vₛ is the Poisson's ratio of the substrate (dimensionless), σ_{f} is a stress of the films (e.g., a net stress, in pascals (Pa)) when formed on the substrate, Eₛ is the Young's modulus of the substrate (e.g., in Pa), and hₛ is the thickness of the substrate (e.g., in m). Accordingly, a warpage of the substrate 210 (e.g., a difference between a maximum distance and a minimum distance of a surface of the substrate 210 from a reference plane associated with the substrate 210, measured in m), when the layer stack 220 is disposed on the substrate 210, may be less than a curvature predicted by the Stoney equation for when the layer stack 220 is formed on the substrate 210. Thus, the optical filter 200 may lie flat (e.g., with little to no curling or bending). For example, because the stress (e.g., the net stress) of the layer stack 220 is approximately zero (0) MPa, the substrate 210 is not likely to warp (e.g., even when the maximum thickness of the substrate 210 satisfies the substrate thickness threshold). In some implementations, the warpage of the substrate is approximately 0 μm (e.g., 0 μm, within a tolerance, such as 1 μm).

As indicated above, FIG. 2 is provided as an example. Other examples may differ from what is described with regard to FIG. 2.

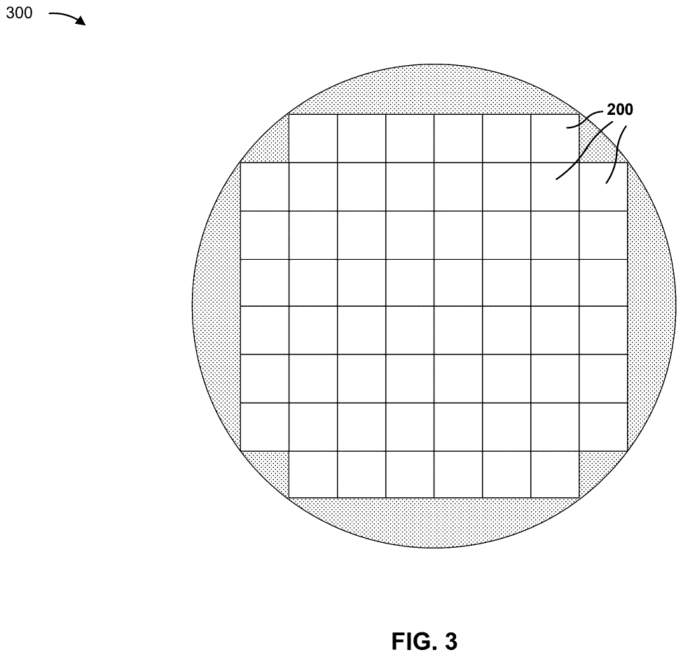

FIG. 3 is a diagram of an example wafer 300. As shown in FIG. 3, the wafer 300 may include a plurality of optical filters 200. Each optical filter 200 may include a portion of the wafer 300 that serves as a substrate (e.g., a substrate 210) for the optical filter 200 and a layer stack 220 disposed on the substrate, such as in a similar manner as that described herein in relation to FIG. 2. For example, the layer stack 220 of each optical filter 200 may include layers that comprise compressive materials and may not include a layer that comprises a tensile material. As another example, each optical filter 200 may have a cuboid shape, and the layer stack 220 of each optical filter 200 may have a minimum horizontal dimension that satisfies a horizontal dimension threshold and/or a minimum thickness that satisfies a layer stack thickness threshold. In a further example, a stress (e.g., a net stress) of the layer stack 220 may be approximately zero MPa.

In some implementations, a maximum thickness of the wafer 300 may satisfy (e.g., may be less than or equal to) a wafer thickness threshold, such as 400 μm. This reduces an overall thickness and weight of each optical filter 200 (e.g., when singulated), enabling use of the optical filters 200 in compact systems and devices, such as user devices (e.g., smart phones), where thickness and weight are critical constraints. Further, a warpage of the wafer is approximately 0 μm (e.g., 0 μm, within a tolerance, such as 1 μm).

As further described herein, the layer stacks 220 of the plurality of optical filters 200 may have been formed on another wafer, such as a thicker wafer, which allowed the layer stacks 220 to form on a surface subject to less warpage and therefore with reduced coating runoff. The layer stacks 220 then may have been released from the other wafer and transferred to the wafer 300. Accordingly, because the layer stacks 220 were formed on the other wafer and therefore have a high quality, and because the layer stacks 220 are disposed on the wafer 300 such that a stress (e.g., a net stress) of each layer stack 220 on the wafer 300 is approximately zero MPa, a threshold percentage of the layer stacks 220 do not include formation defects. The threshold percentage may be, for example, greater than or equal to 50%, 55%, 75%, 85%, 95%, and/or 99%.

A layer stack 220 may include a formation defect when a region on a surface (e.g., a top surface) of the layer stack 220 is chipped, delaminated, and/or otherwise damaged (e.g., as a result of forming the layer stack 220), and the region is greater than or equal to a threshold size. The threshold size may be, for example, greater than or equal to 0.001%, 0.00125%, 0.0025%, 0.0050%, 0.01%, 0.05%, 0.1%, 0.5%, of an area of the surface of the layer stack 220. In some implementations, the threshold size may be greater than or equal to 10 square micrometers (μm²), 20 μm², 30 μm², 40 μm², and/or 50 μm², among other examples. Accordingly, the threshold percentage of the layer stack 220 may not include damaged regions that are greater than or equal to the threshold size.

As indicated above, FIG. 3 is provided as an example. Other examples may differ from what is described with regard to FIG. 3.

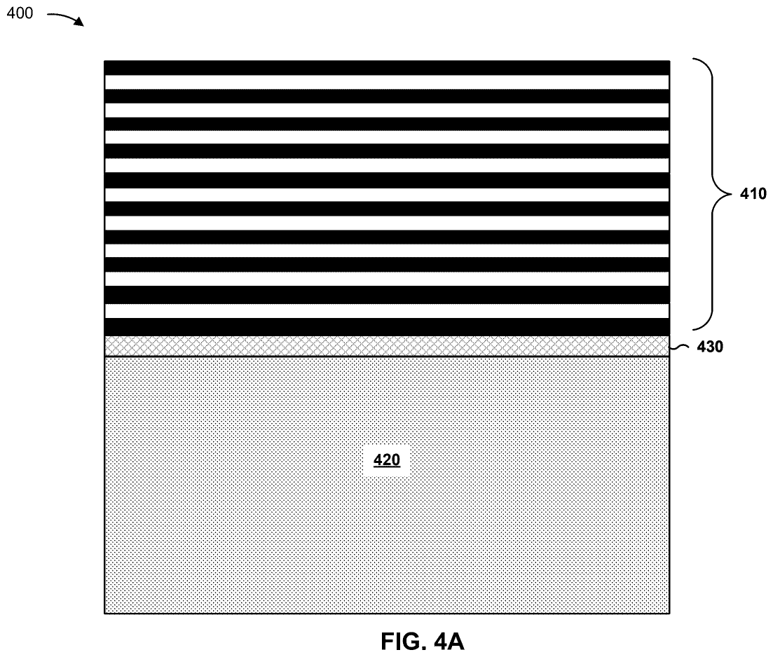

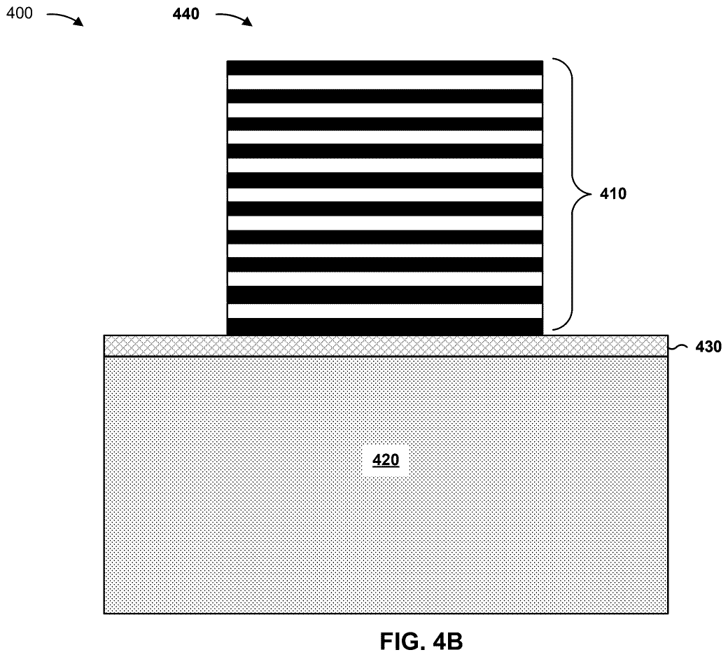

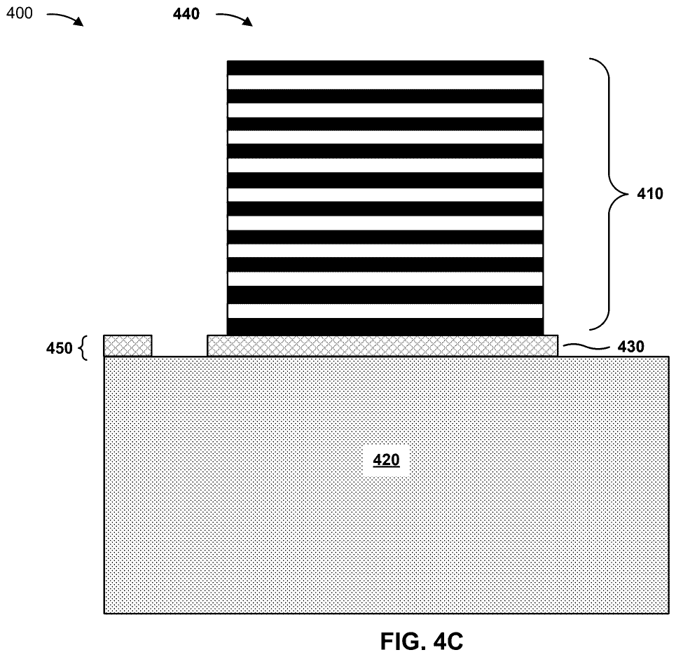

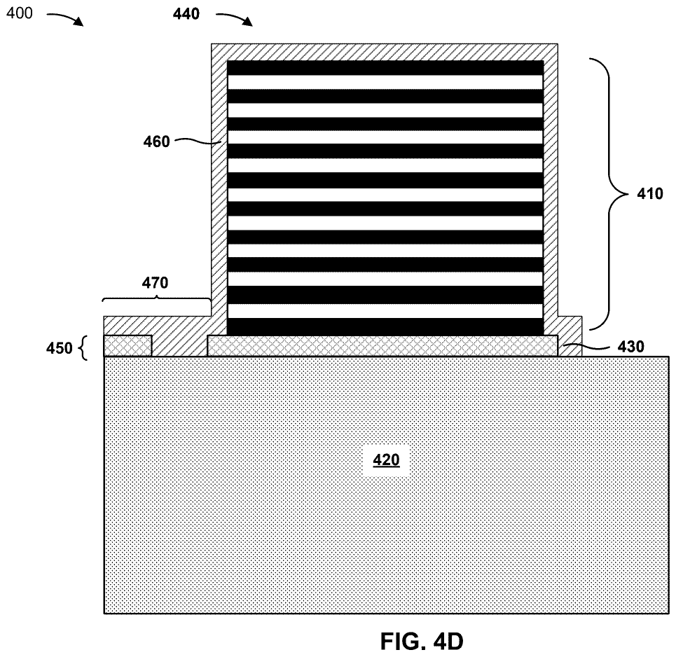

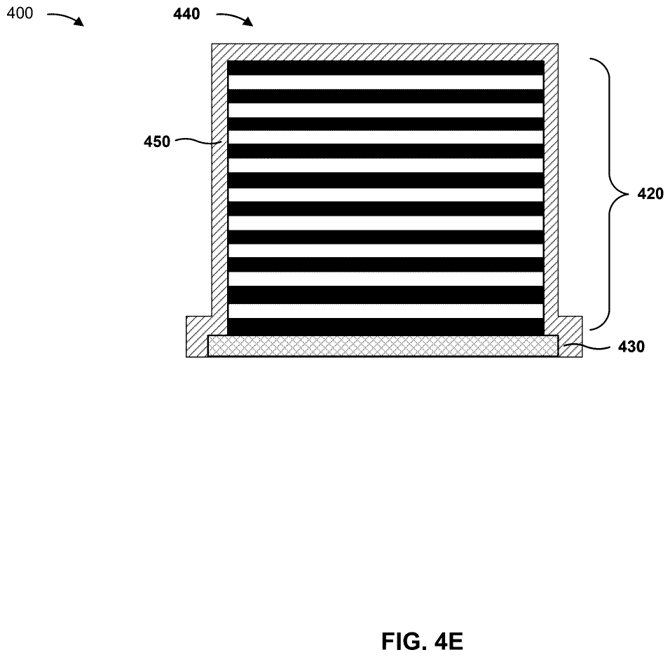

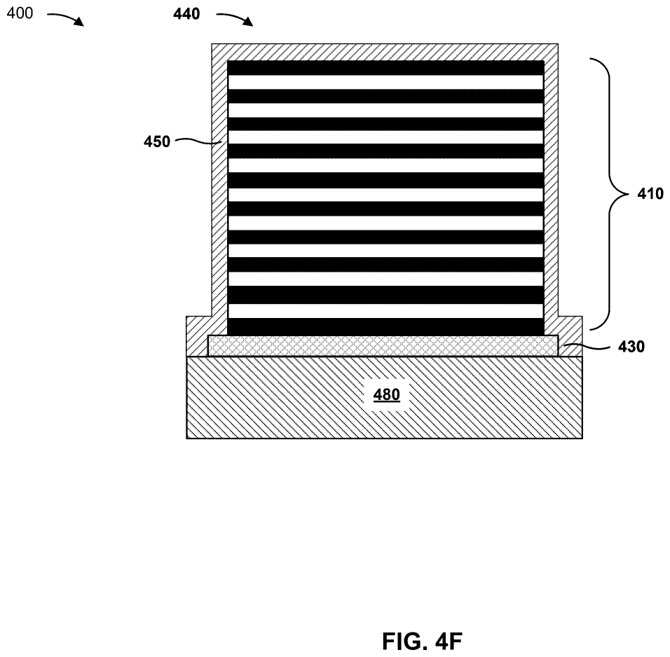

FIGS. 4A-4F are diagrams associated with an example process 400 associated with forming optical filters, such as optical filters 200 described herein.

As shown in FIG. 4A, example process 400 includes forming layers 410 on a first wafer 420. For example, a sputtering technique, such as a magnetron sputtering technique (e.g., a pulsed-magnetron sputtering technique), may be used to sputter the layers 410 on the first wafer 420. In some implementations, the example process 400 includes forming a first set of layers and a second set of layers on the first wafer 420 (e.g., in alternating order on the first wafer 420). Each layer of the first set of layers may comprise a first compressive material and each layer of the second set of layers may comprise a second compressive material that is a different compressive material, in a similar manner as that described elsewhere herein. This may cause a stress (e.g., a net stress) to be induced in the layers 410 (e.g., as a result of a high-temperature sputtering technique that induces a thermal stress due to differences in CTEs of the materials in the layers 410 and the first wafer 420).

As further shown in FIG. 4A, as part of the example process 400, a protective layer 430 may be formed (e.g., using the sputtering technique) on the first wafer 420 prior to formation of the layers 410, such as to cause the protective layer 430 to be disposed between the first wafer 420 and the layers 410. The protective layer 430 may protect the layers 410 during additional steps associated with the example process 400 described herein.

As shown in FIG. 4B, example process 400 includes singulating the layers 410. For example, the example process 400 includes using a singulation technique (e.g., a dicing technique, a dry etching technique, or another type of singulation technique) on the first set of layers and the second set of layers to form a plurality of layer stacks 440 (shown as a singular layer stack in FIG. 4B). The plurality of layer stacks 440 may be formed such that each layer stack 440 has a minimum horizontal dimension that satisfies a horizontal dimension threshold and/or has a minimum thickness that satisfies a layer stack thickness threshold.

As shown in FIG. 4C, example process 400 includes forming respective patio structures 450 for the plurality of layer stacks 440. For example, the example process 400 includes using a patio formation technique (e.g., a dry etching technique, an ablation technique, or another type of patio formation technique) to form a patio structure 450 for each layer stack 440. The patio structure 450 may be formed to facilitate formation of a tether, as further described herein.

As shown in FIG. 4D, example process 400 includes encapsulating the plurality of layer stacks 440. For example, the example process 400 includes using an encapsulation technique (e.g., a sputtering technique, a deposition technique, a spin coating technique, or another type of encapsulation technique) to form an encapsulation layer 460 for each layer stack 440. The encapsulation layer 460 may cover the layer stack 440 and the patio structure 450 associated with the layer stack 440, which may form a tether 470 that facilitates separation of the layer stack 440 from the first wafer 420, as further described herein.

As shown in FIG. 4E, example process 400 includes releasing the plurality of layer stacks 440 from the first wafer 420. For example, the example process 400 includes using a release technique (e.g., a wet etching technique, a mechanical peeling technique, an ablation technique, or another type of release technique) to release each layer stack 440 from the first wafer 420. Releasing the layer stack 440 from the first wafer 420 may also cause the tether 470 to release from the layer stack 440. Further, releasing the layer stack 440 from the first wafer 420 may cause the layer stack 440 to relax, which causes a stress (e.g., the net stress) of the layer stack 440 to decrease to zero, or near-zero, MPa.

As shown in FIG. 4F, example process 400 includes transferring the plurality of layer stacks 440 to a second wafer 480. For example, the example process 400 includes using a transfer technique (e.g., a printing technique, or another type of transfer technique) to transfer each layer stack 440 to the second wafer 480. This causes the plurality of layer stacks 440 to be disposed on the second wafer 480.

Accordingly, the second wafer 480 may comprise a plurality of optical interference filters, wherein each optical interference filter includes a portion of the second wafer 480 that serves as a substrate for the optical interference filter and a layer stack 440 is disposed on the substrate. In some implementations, example process 400 includes singulating (e.g., using a singulation technique) the plurality of layer stacks 440 and respective portions of the second wafer 480 to form the plurality of optical interference filters (e.g., as individual optical interference filters).

In some implementations, the second wafer 480 may be thinner than the first wafer 420. For example, a maximum thickness of the second wafer 480 may be less than a maximum thickness of the first wafer 420 (and may be less than a substrate thickness threshold). Thus, the layers 410 may be formed on the first wafer 420 such that the first wafer 420 undergoes less warpage (as compared to formation on the second wafer 480), which reduces a coating runoff of layers 410 and thereby improves a quality of the plurality of layer stacks 440 that are ultimately transferred to the second wafer 480. Further, a stress (e.g., a net stress) of each layer stack 440 on the second wafer 480 is approximately zero MP because the plurality of layer stacks 440 were released from the first wafer 420, which caused the plurality of layer stacks 440 to relax. Accordingly, a warpage of the second wafer 480 may be approximately 0 μm (e.g., 0 μm, within a tolerance, such as 1 μm).

As indicated above, FIGS. 4A-4F are provided as an example. Other examples may differ from what is described with regard to FIGS. 4A-4F.

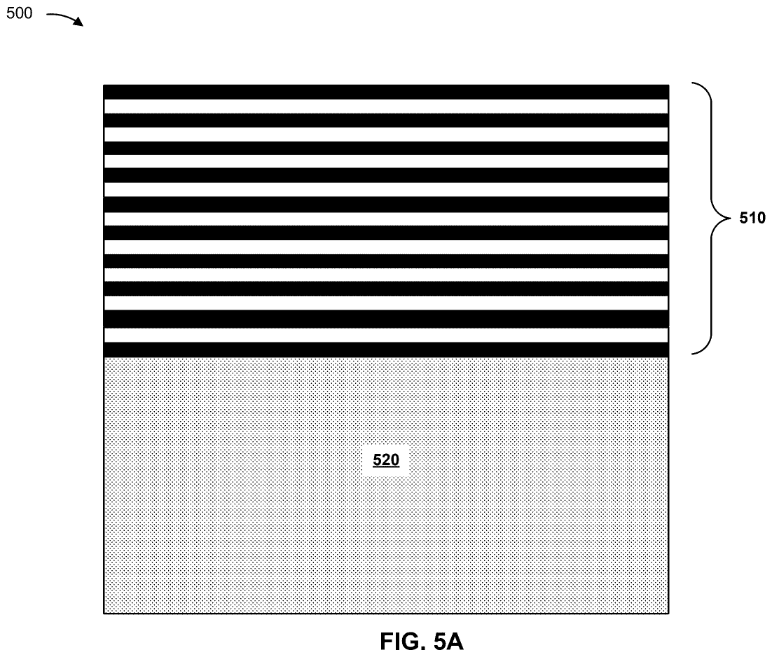

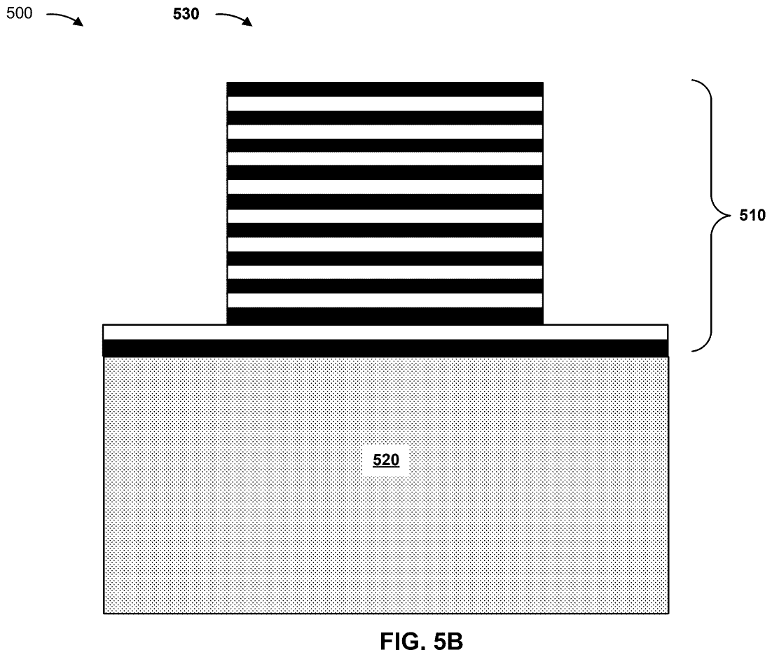

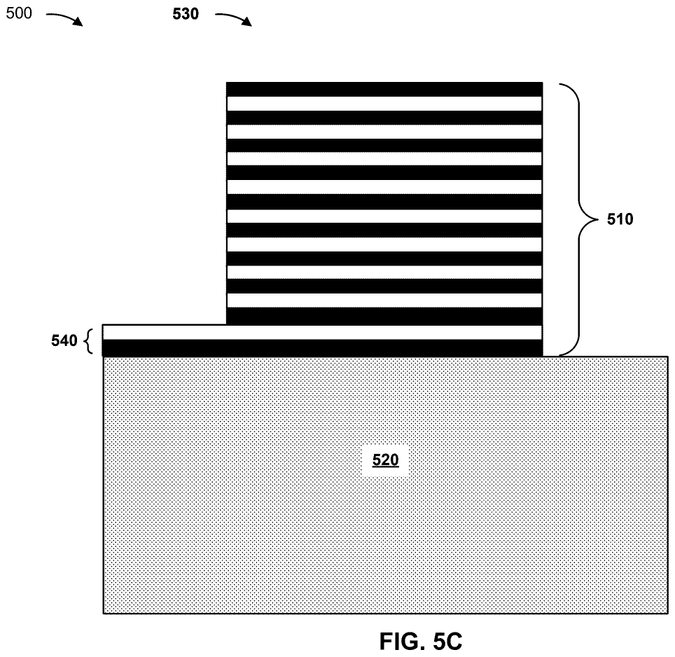

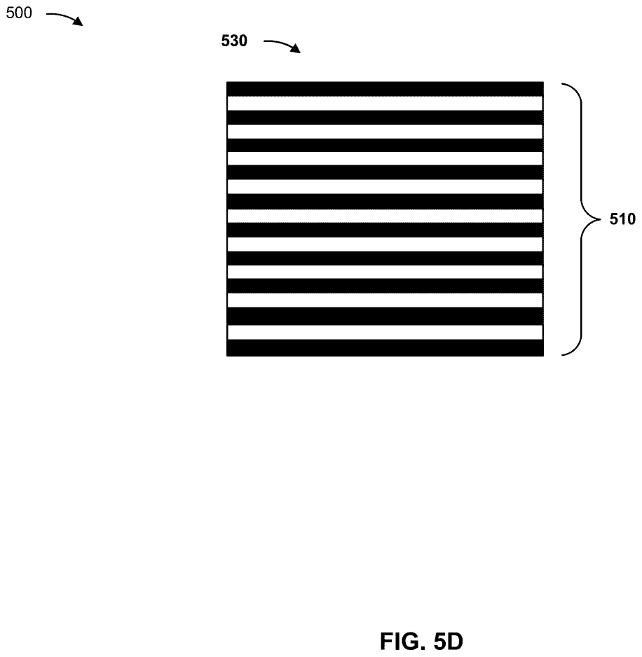

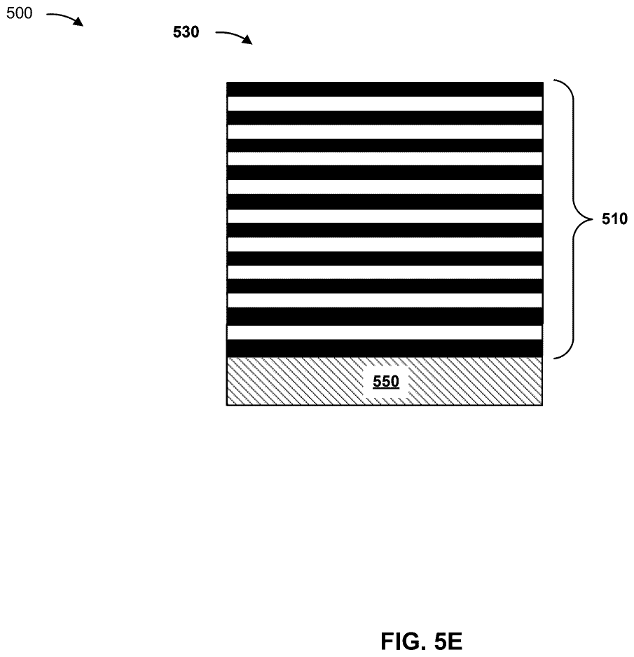

FIGS. 5A-5E are diagrams associated with an example process associated with forming optical filters, such as optical filters 200 described herein.

As shown in FIG. 5A, example process 500 includes forming layers 510 on a first wafer 520. For example, a sputtering technique, such as a magnetron sputtering technique (e.g., a pulsed-magnetron sputtering technique), may be used to sputter the layers 510 on the first wafer 520. In some implementations, the example process 500 includes forming a first set of layers and a second set of layers on the first wafer 520 (e.g., in alternating order on the first wafer 520). Each layer of the first set of layers may comprise a first compressive material, and each layer of the second set of layers may comprise a second compressive material that is a different compressive material, in a similar manner at that described elsewhere herein. This may cause a stress (e.g., a net stress) to be induced in the layers 510 (e.g., as a result of a high-temperature sputtering technique that induces a thermal stress due to differences in CTEs of the materials in the layers 510 and the first wafer 520).

As shown in FIG. 5B, example process 500 includes singulating the layers 510. For example, the example process 500 includes using a singulation technique (e.g., a dicing technique, a dry etching technique, or another type of singulation technique) on the first set of layers and the second set of layers to form a plurality of layer stacks 530 (shown as a singular layer stack in FIG. 5B). The plurality of layer stacks 530 may be formed such that each layer stack 530 has a minimum horizontal dimension that satisfies a minimum horizontal dimension threshold and/or has a thickness that satisfies a layer stack thickness threshold.

As shown in FIG. 5C, example process 500 includes forming respective patio structures 540 for the plurality of layer stacks 530. For example, the example process 500 includes using a patio formation technique (e.g., a dry etching technique, an ablation technique, or another type of patio formation technique) to form a patio structure 540 for each layer stack 530. The patio structure 540 may be formed to facilitate separation of the layer stack 530 from the first wafer 520, as further described herein.

As shown in FIG. 5D, example process 500 includes releasing the plurality of layer stacks 530 from the first wafer 520. For example, the example process 500 includes using a release technique (e.g., a wet etching technique, a mechanical peeling technique, an ablation technique, or another type of release technique) to release each layer stack 530 from the first wafer 520. Releasing the layer stack 530 from the first wafer 520 may also cause the patio structure 540 to release from the layer stack 530. Further, releasing the layer stack 530 from the first wafer 520 may cause the layer stack 530 to relax, which causes a stress (e.g., the net stress) of the layer stack 530 to decrease to zero, or near-zero, MPa.

As shown in FIG. 5E, example process 500 includes transferring the plurality of layer stacks 530 to a second wafer 550. For example, the example process 500 includes using a transfer technique (e.g., a printing technique, or another type of transfer technique) to transfer each layer stack 530 to the second wafer 550. This causes the plurality of layer stacks 530 to be disposed on the second wafer 550.

Accordingly, the second wafer 550 may comprise a plurality of optical interference filters, wherein each optical interference filter includes a portion of the second wafer 550 that serves as a substrate for the optical interference filter and a layer stack 530 is disposed on the substrate. In some implementations, example process 500 includes singulating (e.g., using a singulation technique) the plurality of layer stacks 530 and respective portions of the second wafer 550 to form the plurality of optical interference filters (e.g., as individual optical interference filters).

In some implementations, the second wafer 550 may be thinner than the first wafer 520. For example, a maximum thickness of the second wafer 550 may be less than a maximum thickness of the first wafer 520 (and may be less than a substrate thickness threshold). Thus, the layers 510 may be formed on the first wafer 520 such that the first wafer 520 undergoes less warpage (as compared to formation on the second wafer 550), which reduces a coating runoff of layers 510 and thereby improves a quality of the plurality of layer stacks 530 that are ultimately transferred to the second wafer 550. Further, a stress (e.g., a net stress) of each layer stack 530 on the second wafer 550 is approximately zero MP because the plurality of layer stacks 530 were released from the first wafer 520, which caused the plurality of layer stacks 530 to relax. Accordingly, a warpage of the second wafer 550 may be approximately 0 μm (e.g., 0 μm, within a tolerance, such as 1 μm).

As indicated above, FIGS. 5A-5E are provided as an example. Other examples may differ from what is described with regard to FIGS. 5A-5E.

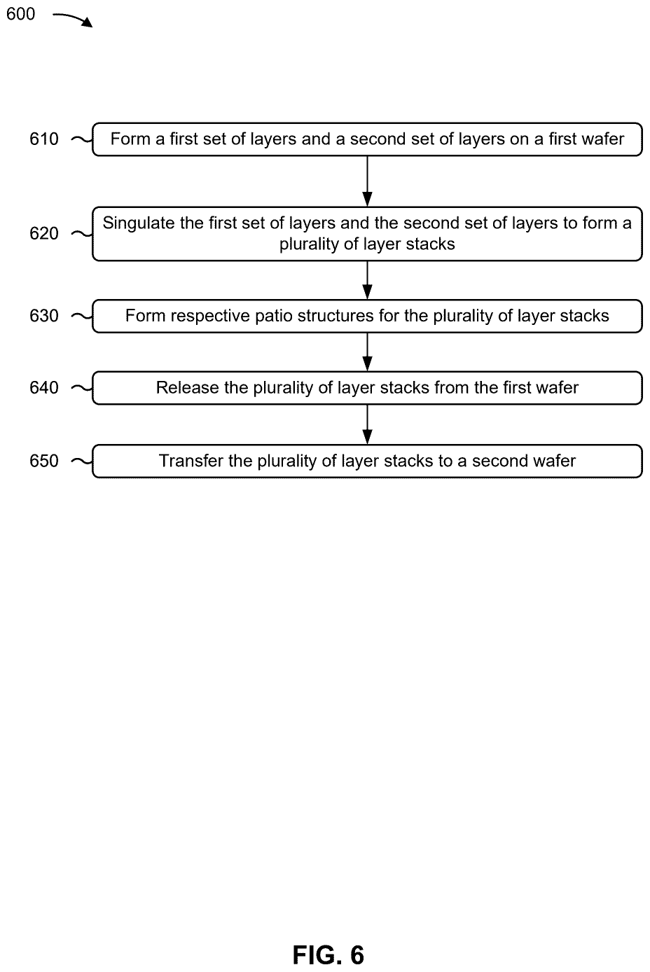

FIG. 6 is a flowchart of an example process 600 associated with forming optical filters, such as optical filters 200 described herein. One or more process blocks of FIG. 6 are performed by a system (e.g., an optical filter manufacturing system) and/or by another device or a group of devices separate from or including the system.

As shown in FIG. 6, process 600 includes forming a first set of layers and a second set of layers on a first wafer (block 610). For example, the system may form a first set of layers and a second set of layers on a first wafer, as described above. The system may use a sputtering technique to form the first set of layers and the second set of layers on the first wafer. In some aspects, each layer of the first set of layers comprises a first compressive material. In some aspects, each layer of the second set of layers comprises a second compressive material that is different than the first compressive material.

As further shown in FIG. 6, process 600 includes singulating the first set of layers and the second set of layers to form a plurality of layer stacks (block 620). For example, the system may singulate the first set of layers and the second set of layers to form a plurality of layer stacks, as described above.

As further shown in FIG. 6, process 600 includes forming respective patio structures for the plurality of layer stacks (block 630). For example, the system may form respective patio structures for the plurality of layer stacks, as described above.

As further shown in FIG. 6, process 600 includes releasing the plurality of layer stacks from the first wafer (block 640). For example, the system may release the plurality of layer stacks from the first wafer, as described above.

As further shown in FIG. 6, process 600 includes transferring the plurality of layer stacks to a second wafer (block 650). For example, the system may transfer the plurality of layer stacks to a second wafer, as described above. In some aspects, a net stress of each layer stack on the second wafer is approximately zero MPa.

Process 600 may include additional aspects, such as any single aspect or any combination of aspects described below and/or in connection with one or more other processes described elsewhere herein.

In a first aspect, a maximum thickness of the second wafer is less than a maximum thickness of the first wafer.

In a second aspect, alone or in combination with the first aspect, a maximum thickness of the second wafer is less than or equal to 100 μm, 150 μm, 200 μm, 250 μm, 300 μm, 350 μm, or 400 μm.

In a third aspect, alone or in combination with one or more of the first and second aspects, process 600 includes singulating the plurality of layer stacks and respective portions of the second wafer to form a plurality of optical interference filters.

In a fourth aspect, alone or in combination with one or more of the first through third aspects, a minimum horizontal dimension of each layer stack on the second wafer is greater than 1 mm.

In a fifth aspect, alone or in combination with one or more of the first through fourth aspects, a minimum thickness of each layer stack on the second wafer is greater than 10 μm.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
forming, using a sputtering technique, a first set of layers and a second set of layers on a first wafer,
wherein each layer of the first set of layers comprises a first compressive material, and
wherein each layer of the second set of layers comprises a second compressive material that is different than the first compressive material;
singulating the first set of layers and the second set of layers to form a plurality of layer stacks;
forming respective patio structures for the plurality of layer stacks;
releasing the plurality of layer stacks from the first wafer; and
transferring the plurality of layer stacks to a second wafer,
wherein a maximum thickness of the second wafer is less than a maximum thickness of the first wafer, and
wherein a net stress of each layer stack on the second wafer is approximately zero megapascals.

2. The method of claim 1, wherein a warpage of the second wafer is approximately 0 micrometers.

3. The method of claim 1, wherein an aspect ratio of a maximum thickness of each layer stack and a maximum horizontal dimension of the layer stack, when transferred to the second wafer, is less than 1:200.

4. The method of claim 1, further comprising:
singulating the plurality of layer stacks and respective portions of the second wafer to form a plurality of optical interference filters.

5. The method of claim 1, wherein a minimum horizontal dimension of each layer stack on the second wafer is greater than 1 millimeter (mm).

6. An optical interference filter, comprising:
a substrate; and
a layer stack disposed on the substrate, wherein the layer stack includes:
a first set of layers, and
a second set of layers, wherein:
each layer of the first set of layers comprises a first compressive material,
each layer of the second set of layers comprises a second compressive material that is different than the first compressive material,
the layer stack does not include layers that fully compensate for a compressive stress of the first set of layers and the second set of layers, and
a net stress of the layer stack is approximately zero megapascals.

7. The optical interference filter of claim 6, wherein a warpage of the substrate is approximately 0 micrometers.

8. The optical interference filter of claim 6, wherein the optical interference filter has a cuboid shape.

9. The optical interference filter of claim 6, wherein a minimum horizontal dimension of the layer stack is greater than 1 millimeter.

10. The optical interference filter of claim 6, wherein an aspect ratio of a maximum thickness of the layer stack and a maximum horizontal dimension of the layer stack is less than 1:200.

11. The optical interference filter of claim 6, wherein a maximum thickness of the substrate is less than or equal to 400 micrometers.

12. The optical interference filter of claim 6, wherein the substrate comprises:
a glass substrate;
a polymer substrate;
a polycarbonate substrate;
a metal substrate;
a silicon (Si) substrate;
a germanium (Ge) substrate; or
an active device wafer.

13. The optical interference filter of claim 6, wherein the layer stack is disposed on a single surface of the substrate.

14. The optical interference filter of claim 6, wherein the first set of layers and the second set of layers are disposed on the substrate in an alternating layer order.

15. A wafer, comprising:
a plurality of optical interference filters, wherein each optical interference filter includes:
a portion of the wafer that serves as a substrate for the optical interference filter; and
a layer stack disposed on the substrate, wherein the layer stack includes:
a first set of layers, and
a second set of layers, wherein:
each layer of the first set of layers comprises a first compressive material,
each layer of the second set of layers comprises a second compressive material that is different than the first compressive material,
the layer stack does not include layers that fully compensate for a compressive stress of the first set of layers and the second set of layers, and
a net stress of the layer stack is approximately zero megapascals.

16. The wafer of claim 15, wherein a warpage of the wafer is approximately 0 micrometers.

17. The wafer of claim 15, wherein an aspect ratio of a maximum thickness of each layer stack and a maximum horizontal dimension of the layer stack is less than 1:200.

18. The wafer of claim 15, wherein a minimum horizontal dimension of the layer stack of each optical interference filter is greater than 1 millimeter.

19. The wafer of claim 15, wherein a maximum thickness of the wafer is less than or equal to 400 micrometers (μm).

20. The wafer of claim 15, wherein the first set of layers and the second set of layers are disposed on the substrate in an alternating layer order.
